(19) United States
(12) Patent Application Publication
(10) Pub. No.: US 2024/0284407 A1
(43) Pub. Date: Aug. 22, 2024

(54) SIDELINK RESPONSE TIME VALUE SELECTION

(71) Applicant: Nokia Technologies Oy, Espoo (FI)

(72) Inventors: Prajwal KESHAVAMURTHY, Munich (DE); Oana-Elena BARBU, Aalborg (DE); Torsten WILDSCHEK, Gloucester (GB); Ryan KEATING, Naperville, IL (US); Hyun-Su CHA, Naperville, IL (US)

(21) Appl. No.: 18/432,539

(22) Filed: Feb. 5, 2024

Related U.S. Application Data
(60) Provisional application No. 63/485,334, filed on Feb. 16, 2023.

(51) Int. Cl. H04W 72/02; H04L 5/00; H04W 72/0446; H04W 72/40; H04W 72/51; H04W 92/18

(52) U.S. Cl. CPC H04W 72/02; H04L 5/0051; H04W 72/0446; H04W 72/40; H04W 72/51; H04W 92/18

(57) ABSTRACT

An anchor user equipment is configured to: select a sidelink response time value from a plurality of sidelink response time values configured for the user equipment and a target user equipment; and transmit a positioning reference signal to the target user equipment based at least partly on at least one positioning reference signal transmission parameter associated with the selected sidelink response time value. A target user equipment is configured to: receive a positioning reference signal transmitted by an anchor user equipment; identify at least one positioning reference signal transmission parameter associated with the received positioning reference signal; and determine, based on the at least one positioning reference signal transmission parameter, a sidelink response time value for transmission of the received positioning reference signal by the anchor user equipment, the sidelink response time value being for determining position information for the user equipment.

### TECHNICAL FIELD

One or more example embodiments relate to wireless communications networks.

### BACKGROUND

Fifth generation (5G) wireless communications networks are the next generation of mobile communications networks. Standards for 5G networks are currently being developed by the 3rd Generation Partnership Project (3GPP). These standards are known as 3GPP New Radio (NR) standards.

### SUMMARY

The scope of protection sought for various example embodiments is set out by the independent claims. The example embodiments and/or features, if any, described in this specification that do not fall under the scope of the independent claims are to be interpreted as examples useful for understanding various embodiments.

One or more example embodiments may improve positioning accuracy in, for example, a report-free Sidelink Round Trip Time (SL RTT) positioning session (also referred to herein as a SL positioning session) by providing higher accuracy SL RTT response time indication and/or improve SL positioning reference signal (SL PRS) reception quality at a user equipment (UE). One or more example embodiments may also improve system level SL positioning performance since an anchor UE may suppress and/or minimize its SL PRS transmission impact on other SL PRS transmissions (from other UEs) by selecting a more suitable transmission time.

According to one or more example embodiments, an anchor UE may implicitly indicate a Rx-Tx time value (also referred to herein as a response time value, a sidelink response time value or a receive-to-transmit time or time value) to a target UE for position determination by utilizing a SL PRS transmission parameter that is mapped to a given Rx-Tx time value.

At least one example embodiment provides a user equipment comprising: at least one processor and at least one memory. The at least one memory stores instructions that, when executed by the at least one processor, cause the user equipment to: select a sidelink response time value from a plurality of sidelink response time values configured for the user equipment and a target user equipment; and transmit a positioning reference signal to the target user equipment based at least partly on at least one positioning reference signal transmission parameter associated with the selected sidelink response time value.

At least one other example embodiment provides a method comprising: selecting, at a user equipment, a sidelink response time value from a plurality of sidelink response time values configured for the user equipment and a target user equipment; and transmitting, from the user equipment, a positioning reference signal to the target user equipment based at least partly on at least one positioning reference signal transmission parameter associated with the selected sidelink response time value.

At least one other example embodiment provides a user equipment comprising: means for selecting a sidelink response time value from a plurality of sidelink response time values configured for the user equipment and a target user equipment; and means for transmitting a positioning reference signal to the target user equipment based at least partly on at least one positioning reference signal transmission parameter associated with the selected sidelink response time value.

The at least one positioning reference signal transmission parameter may include at least one of a positioning reference signal sequence for the positioning reference signal, a positioning reference signal sequence for a positioning reference signal identifier, frequency resources for transmitting the positioning reference signal, time resources for transmitting the positioning reference signal, or frequency offset information.

The at least one positioning reference signal transmission parameter may be a resource pool used to transmit the positioning reference signal to the target user equipment.

The at least one memory may store instructions that, when executed by the at least one processor, cause the user equipment to select transmission time of the positioning reference signal according to the selected sidelink response time value.

The at least one positioning reference signal transmission parameter may be associated with a parameter identifier. The sidelink response time value may be associated with the at least one positioning reference signal transmission parameter via a mapping between the sidelink response time value and the parameter identifier.

The at least one positioning reference signal transmission parameter may include at least one of a positioning reference signal sequence for the positioning reference signal or frequency resources for transmitting the positioning reference signal.

The sidelink response time value may be mapped to the parameter identifier via a mapping table.

The at least one memory may store instructions that, when executed by the at least one processor, cause the user equipment to receive a positioning reference signal from the target user equipment prior to selecting the sidelink response time value. The sidelink response time value may indicate a time difference between receipt of the positioning reference signal from the target user equipment and transmission of the positioning reference signal to the target user equipment.

The at least one memory may store instructions that, when executed by the at least one processor, cause the user equipment to select the sidelink response time value from the plurality of sidelink response time values based on at least one of sidelink channel characteristics between the user equipment and the target user equipment, positioning requirements for the target user equipment, or priority information associated with positioning reference signal transmissions from at least one of the user equipment or the target user equipment.

Transmission of the positioning reference signal to the target user equipment based at least partly on the at least one positioning reference signal transmission parameter may indicate the sidelink response time value to the target user equipment without explicit transmission of the sidelink response time value to the target user equipment.

At least one other example embodiment provides a user equipment comprising: at least one processor and at least one memory. The at least one memory stores instructions that, when executed by the at least one processor, cause the user equipment to: receive a positioning reference signal transmitted by an anchor user equipment; identify at least one positioning reference signal transmission parameter associated with the received positioning reference signal; and determine, based on the at least one positioning reference signal transmission parameter, a sidelink response time value for transmission of the received positioning reference signal by the anchor user equipment, the sidelink response time value being for determining position information for the user equipment.

At least one other example embodiment provides a method comprising: receiving, at a user equipment, a positioning reference signal transmitted by an anchor user equipment; identifying, at the user equipment, at least one positioning reference signal transmission parameter associated with the received positioning reference signal; and determining, at the user equipment, based on the at least one positioning reference signal transmission parameter, a sidelink response time value for transmission of the received positioning reference signal by the anchor user equipment, the sidelink response time value being for determining position information for the user equipment.

At least one other example embodiment provides a user equipment comprising: means for receiving a positioning reference signal transmitted by an anchor user equipment; means for identifying at least one positioning reference signal transmission parameter associated with the received positioning reference signal; and means for determining based on the at least one positioning reference signal transmission parameter, a sidelink response time value for transmission of the received positioning reference signal by the anchor user equipment, the sidelink response time value being for determining position information for the user equipment.

The position information may include at least one of an absolute position, a relative position, or ranging information for the user equipment.

The at least one positioning reference signal transmission parameter may include at least one of a positioning reference signal sequence for the positioning reference signal, a positioning reference signal sequence for a positioning reference signal identifier, frequency resources for transmitting the received positioning reference signal, time resources for transmitting the received positioning reference signal, or frequency offset information.

The at least one positioning reference signal transmission parameter may be a resource pool used to transmit the received positioning reference signal.

The at least one positioning reference signal transmission parameter may be associated with a parameter identifier, the sidelink response time value may be associated with the at least one positioning reference signal transmission parameter via a mapping between the parameter identifier and the sidelink response time value, and the at least one memory may store instructions that, when executed by the at least one processor, cause the user equipment to determine the sidelink response time value based on the parameter identifier.

The sidelink response time value may be mapped to the parameter identifier via a mapping table.

The at least one positioning reference signal transmission parameter may include at least one of a positioning reference signal sequence for the positioning reference signal or frequency resources for transmitting the positioning reference signal.

The at least one memory may store instructions that, when executed by the at least one processor, cause the user equipment to transmit a positioning reference signal to the anchor user equipment, wherein the sidelink response time value is a time difference between receipt of the position reference signal transmitted to the anchor user equipment and transmission of the position reference signal from the anchor user equipment.

The at least one memory may store instructions that, when executed by the at least one processor, cause the user equipment to determine the sidelink response time value based on the at least one positioning reference signal transmission parameter without explicit receipt of the sidelink response time value from the anchor user equipment.

The at least one memory may store instructions that, when executed by the at least one processor, cause the user equipment to determine position information for the user equipment based on the sidelink response time value.

The position information may be UE-based position information or UE-assisted position information.

The at least one memory may store instructions that, when executed by the at least one processor, cause the user equipment to report at least one of a round trip time measurement, anchor UE identifier, or target UE identifier to a location server or location management function for position determination.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates an example sidelink (SL) positioning scenario where a target user equipment (UE) is exchanging SL positioning reference signals (PRS) with three anchor UEs.

FIG. 2A is a signal flow diagram illustrating a method according to example embodiments.

FIG. 2B is a signal flow diagram illustrating a method according to example embodiments.

FIG. 2C is a signal flow diagram illustrating a method according to example embodiments.

FIG. 3 is a block diagram illustrating an example embodiment of a UE.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

It will be appreciated that a number of example embodiments described herein may be used in combination.

While one or more example embodiments may be described from the perspective of a user equipment (UE), it should be understood that one or more example embodiments discussed herein may be performed by one or more processors (or processing circuitry) at the applicable device. For example, according to one or more example embodiments, at least one memory may include or store computer-executable instructions that, when executed by at least one processor, cause the UE to perform one or more operations discussed herein.

As discussed herein, the terminology “one or more” and “at least one” may be used interchangeably.

As discussed herein, a gNB may also be referred to as a base station, access point, enhanced NodeB (eNodeB), or more generally, a radio access network element, radio network element, or network node. A UE may also be referred to herein as a mobile station, and may include a mobile phone, a cell phone, a smartphone, a handset, a personal digital assistant (PDA), a tablet, a laptop computer, a phablet, a vehicle including a vehicular communication system, an Internet-of-Things (IOT) device, or the like.

As discussed herein, transmission resources may also be referred to as radio or cellular resources for transmitting, and may include, for example, time and/or frequency resources for transmitting information and/or data between devices.

Sidelink (SL) is a communication paradigm in which UEs are able to communicate without relaying data via the network. SL communication (sometimes referred to herein simply as SL) uses communication periods that are periodic in the time domain. Each SL period includes instances of a Physical Sidelink Control Channel (PSCCH), which carries signaling traffic (control information), and a Physical Sidelink Shared Channel (PSSCH), which primarily carries data.

As discussed herein, a “target UE” refers to a UE to be positioned using SL (PC5 interface). An “anchor UE” refers to a UE supporting positioning of target UE, for example, by transmitting and/or receiving reference signals for positioning, providing positioning-related information, etc., over the SL interface (PC5 interface).

SL positioning refers to positioning of a UE using reference signals transmitted over SL, to obtain absolute position of the UE (e.g., a target UE), relative position of the UE (e.g., a target UE), or ranging information for the UE (e.g., a target UE). Ranging refers to the determination of the distance and/or the direction between a UE and another entity, such as an anchor UE.

In more detail, SL positioning may be (i) based on the transmissions of SL positioning reference signals (PRS) by multiple anchor UEs to be received by a target UE according to, for example, SL time difference of arrival (TDOA) methods or (ii) based on SL PRS exchange between anchor UEs and a target UE in, for example, SL (multi-)RTT methods to enable localization of the target UE within relatively precise latency and accuracy requirements of the corresponding SL positioning session. SL PRSs are reference signals transmitted over SL for position determination of UEs. SL PRS may also be referred to herein as a positioning reference signal or more generally a reference signal.

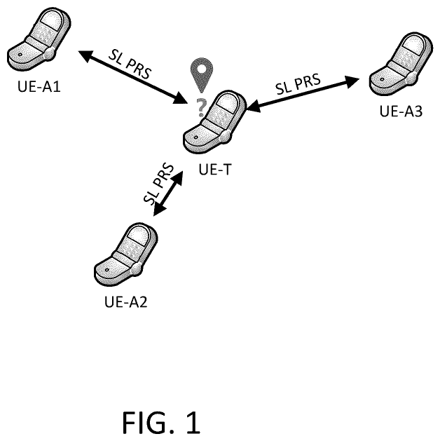

FIG. 1 illustrates an example SL positioning scenario where a target UE UE-T is performing SL positioning session (exchanging SL PRS) with three anchor UEs UE-A1, UE-A2 and UE-A3 in order to determine its location using a SL multi-RTT method (also referred to herein as SL RTT or the SL RTT method). Here, the anchor UEs UE-A1, UE-A2 and UE-A3 are said to provide SL PRS assistance, including SL PRS, to the target UE UE-T. Although only three anchor UEs are shown in FIG. 1, example embodiments should not be limited to this example. Rather, there may be more or less anchor UEs.

SL RTT utilizes two-way SL PRS transmission and reception between target UE and anchor UEs, and is robust to time synchronization between transmitters and receivers. When tight time synchronization is not guaranteed, SL RTT may still be used for SL positioning of a target UE.

In the SL RTT method, a SL Rx-Tx time difference between a received SL PRS transmission and a transmitted SL PRS transmission is measured and reported by anchor UE and/or target UE to estimate the propagation delay, and in turn the distance between the pair of UEs. For example, with regard to target UE UE-T and anchor UE UE-A1 in FIG. 1, the target UE UE-T transmits a first SL PRS to anchor UE UE-A1, and the anchor UE UE-A1 transmits a response including a second SL PRS and a Rx-Tx time difference measurement where anchor UE UE-A1 performs the Rx-Tx time difference measurement considering the receive timing of the first SL PRS from the target UE UE-T and the transmit timing of the second SL PRS to the target UE UE-T.

In conventional report-free SL RTT, the Rx-Tx time for a pair of UEs is fixed and known in advance and the transmission time of SL PRS is adjusted based on the actual time of reception of corresponding SL PRS to comply with the fixed response time (Rx-Tx time=configured fixed Rx-Tx value). Therefore, Rx-Tx time difference measurement need not be reported, which may reduce signaling overhead. Also, this may reduce latency since there is no need for selection of radio resources (e.g., PSSCH resources) and transmission of the measurement report. Still further, this may also reduce channel congestion with reduced channel occupancy.

As noted similarly above, in conventional report-free SL RTT, an anchor UE is made to respond to the target UE by applying a receive-to-transmit offset equal to a fixed Rx-Tx time value (Rx-Tx time=configured fixed Rx-Tx value) so that the anchor UE does not need to report Rx-Tx time to the target UE. However, having a fixed Rx-Tx time may also be too restrictive for compliance by the anchor UE since, for example, the anchor UE may not be able to find suitable interference-limited radio resources for transmission as per the fixed Rx-Tx time. For example, the anchor UE may need to wait for a later slot to transmit the responding SL PRS due to resources being reserved/used by other UEs. In addition, the anchor UE may have higher priority transmissions, which may not allow the anchor UE to abide by the fixed Rx-Tx time. In these instances (e.g., when anchor UE is not able to strictly meet the fixed Rx-Tx time difference), positioning estimate at the target UE based on the fixed Rx-Tx time may be less accurate. In one example, this performance degradation may not be suitable for use cases such as vehicle-to-everything (V2X), industrial-internet-of-things (IIoT), public safety, etc., which may require relatively high positioning accuracy.

One or more example embodiments provide mechanisms to allow flexibility in choosing a suitable Rx-Tx time at an anchor UE for report-free SL RTT. For example, according to one or more example embodiments, multiple Rx-Tx time values (a pool of Rx-Tx time values) may be configured for a report-free SL RTT session between a target UE and an anchor UE, wherein each Rx-Tx time value is associated with (or mapped to) at least one SL PRS transmission parameter (also referred to herein as at least one positioning reference signal transmission parameter). In one example, the at least one SL PRS transmission parameter may be a specific SL PRS configuration (e.g., SL PRS sequence). In this example, a unique SL PRS configuration (e.g., unique SL PRS sequence) is used to indicate a given Rx-Tx time difference to the receiving UE implicitly without explicit transmission of the Rx-Tx time difference. Within the SL RTT positioning session, upon receiving a SL PRS from the target UE, the anchor UE selects a Rx-Tx time value from the configured pool of Rx-Tx time values as the Rx-Tx time to generate its response and performs SL PRS transmission (transmits a SL PRS) according to the at least one SL PRS transmission parameter (e.g., using the SL PRS configuration) and the selected Rx-Tx time. The target UE receives the SL PRS transmission from the anchor UE and derives the Rx-Tx time applied at the anchor UE based on the at least one SL PRS transmission parameter of the received SL PRS (e.g., received SL PRS sequence) and the configured mapping between Rx-Tx time values and SL PRS transmission parameters (e.g., SL PRS sequences).

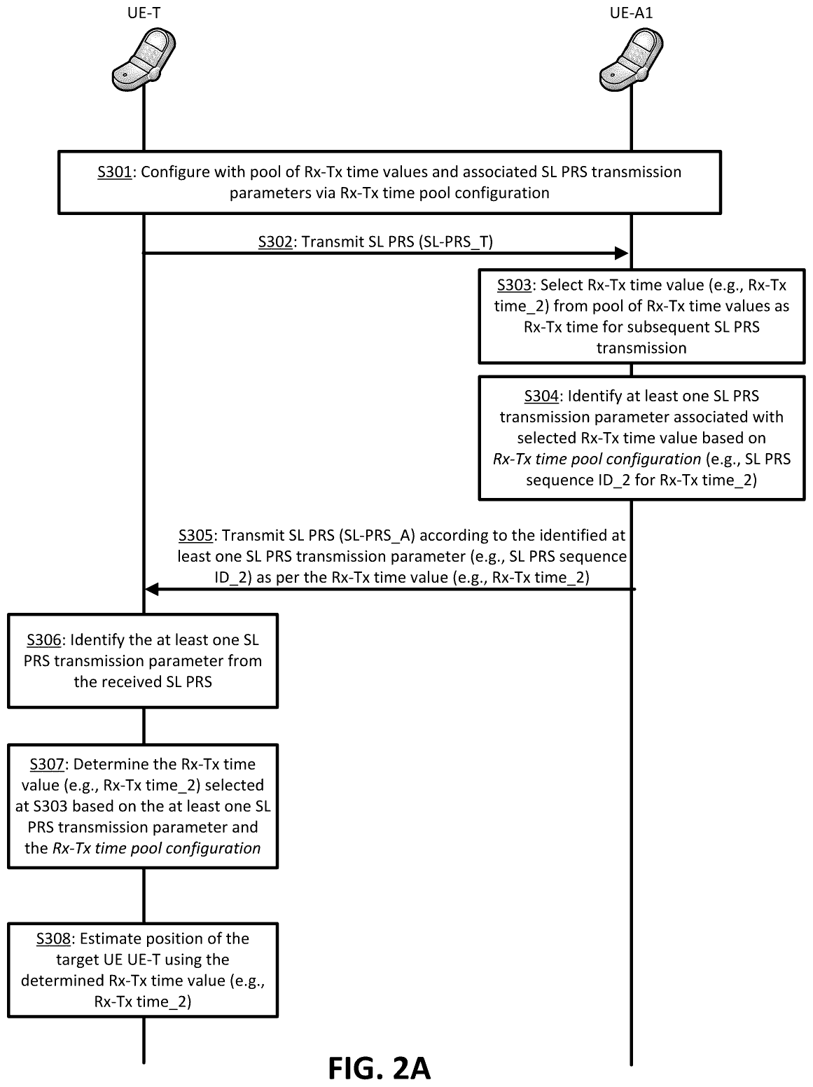

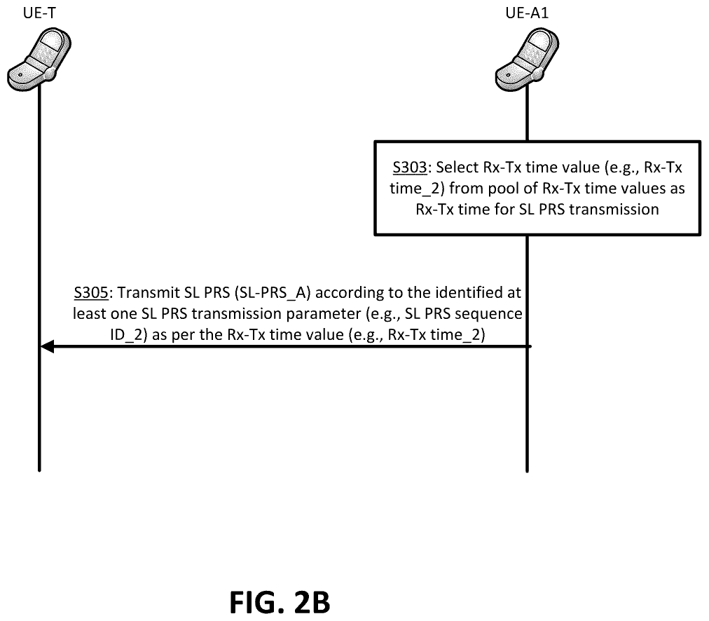

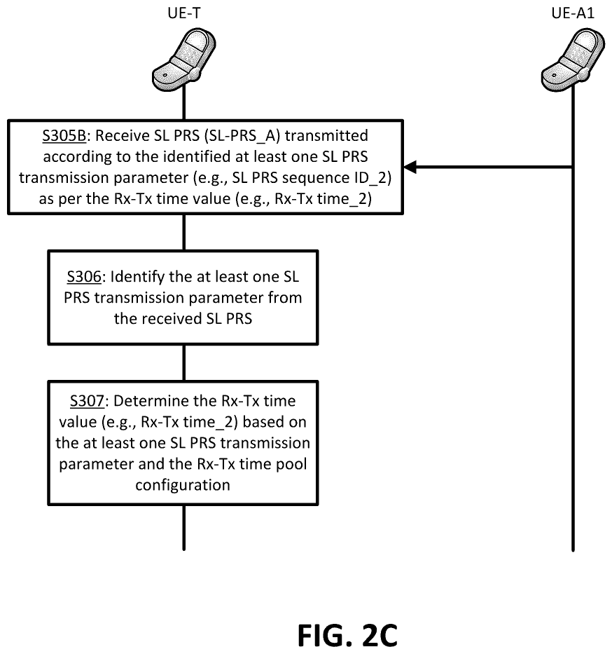

According to one or more example embodiments, the at least one SL PRS transmission parameter may include, for example, different time resources for SL PRS transmission, frequency resources (e.g., combined offset) for SL PRS transmission, SL PRS sequences, a combination of one or more of the foregoing, or the like. Example functionality of the target UE and the anchor UE, according to one or more example embodiments, will be discussed in more detail below and then with regard to FIGS. 2A-2C.

According to at least one example embodiment, an anchor UE may be configured to: perform SL RTT positioning with a target UE; receive a Rx-Tx time pool configuration (e.g., from the anchor UE or another network element) or send a Rx-Tx time pool configuration to the target UE; receive a first SL PRS from the target UE; select, as the Rx-Tx time, a Rx-Tx time value from the pool of Rx-Tx time values indicated in the Rx-Tx time pool configuration; identify at least one SL PRS transmission parameter (e.g., the SL PRS sequence) associated with the selected Rx-Tx time value from the Rx-Tx time pool configuration; and/or transmit a second SL PRS according to the at least one SL PRS transmission parameter and as per the selected Rx-Tx time value. The Rx-Tx time pool configuration may map (or associate) a pool of Rx-Tx time values with corresponding SL PRS transmission parameters (e.g., a mapping table which maps each Rx-Tx time value to one or more SL PRS transmission parameters). In one example, the Rx-Tx time pool configuration may include a pool of Rx-Tx time values and corresponding SL PRS transmission parameter identifiers (also referred to herein as parameter identifiers) in the form of a mapping table which maps each Rx-Tx time value in the pool to a unique SL PRS transmission parameter identifier, wherein each of the identifiers identifies one or more SL PRS transmission parameters. Example SL PRS transmission parameters will be discussed in more detail later.

The Rx-Tx time pool configuration may be received from, for example, a location management function (LMF), another UE (e.g., a server UE), the target UE, a gNB, etc. In another example, the Rx-Tx time pool configuration may be generated at the anchor UE and then provided to target UE (e.g., when establishing the SL RTT positioning session between the anchor UE and the target UE). The anchor UE may select the Rx-Tx time value for transmission of the SL PRS based on, for example, one or more of an interference situation at the SL PRS channel, priority of SL PRS transmission, positioning requirements of the target UE, etc.

A target UE may be configured to: perform SL RTT positioning with an anchor UE; send a Rx-Tx time pool configuration to an anchor UE or receive a Rx-Tx time pool configuration (e.g., from the anchor UE or another network element); transmit a first SL PRS to the anchor UE; receive a second SL PRS from the anchor UE; identify at least one SL PRS transmission parameter (e.g., a SL PRS sequence) for the received second SL PRS; determine the Rx-Tx time value used at the anchor UE for transmission of the second SL PRS based on the identified at least one SL PRS transmission parameter and the Rx-Tx time pool configuration; and/or estimate position of the target UE using at least the determined Rx-Tx time value. In one example, the Rx-Tx time pool configuration may be provided to the target UE by the LMF, another UE (e.g., a server UE), the anchor UE, a gNB, etc. In another example, the target UE may generate the Rx-Tx time pool configuration and send the Rx-Tx time pool configuration to the anchor UE (e.g., when establishing the SL RTT positioning session between the anchor UE and the target UE).

The ability to flexibly select transmission time of SL PRS and hence Rx-Tx time values at the anchor UE, according to one or more example embodiments, may enable the anchor UE to perform SL PRS transmission in a suitable SL PRS resource, for example, interference limited, which may improve SL PRS reception quality at the target UE. A pool of Rx-Tx time values may be configured for a SL RTT positioning session where the anchor UE may more flexibly select a Rx-Tx time value (hence the transmission time of SL PRS) from the pool. The selected or chosen Rx-Tx time value may then conveyed to the target UE in a report-free manner to exploit the benefits of report-free SL RTT. In this regard, each Rx-Tx time value in the pool is associated with at least one SL PRS transmission parameter (e.g., a unique SL PRS sequence) so that the anchor UE is able to indicate the Rx-Tx time value implicitly (without additional signaling) to the target UE by using the corresponding SL PRS transmission parameter(s) for the response SL PRS transmission. The target UE then determines the Rx-Tx time value based on the at least one SL PRS transmission parameter for the received SL PRS and determines its position using the determined Rx-Tx time value.

FIG. 2A is a signal flow diagram illustrating a method according to example embodiments. For example purposes, the example embodiment shown in FIG. 2A will be discussed with regard to the target UE-T and the anchor UE-A1 shown in FIG. 1. However, example embodiments should not be limited to this example. It should be understood that the communication and functionality discussed with regard to FIG. 2A is applicable to any and all of the UEs shown in FIG. 1 (e.g., target UEs may be anchor UEs and vice versa). Additionally, the method shown in FIG. 2A may be performed concurrently and/or simultaneously between the target UE UE-T and one or more of the anchor UEs UE-A1, UE-A2 and UE-A3. For the sake of clarity, some cases may be discussed with regard to SL PRS transmission parameters as SL PRS sequences. However, example embodiments should not be limited by this example discussion.

Referring to FIG. 2A, during a report-free SL RTT positioning session (also referred to herein as a report-free positioning session, a sidelink positioning session or a positioning session) between target UE UE-T and anchor UE UE-A1, at S301 target UE UE-T and anchor UE UE-A1 are configured with a pool of Rx-Tx time values (also referred to herein as a plurality of Rx-Tx time values) for the report-free SL RTT positioning session via a Rx-Tx time pool configuration, where each Rx-Tx time value is associated with (or mapped to) at least one SL PRS transmission parameter. The at least one SL PRS transmission parameter associated with each Rx-Tx time value may be individually unique or a unique combination of SL PRS transmission parameters. For example, each Rx-Tx time value of the pool of Rx-Tx time values may be associated with different SL PRS transmission parameter or parameters. For example, a first Rx-Tx time value may be associated with a first SL PRS transmission parameter or a first set of SL PRS transmission parameters and a second Rx-Tx time value (that is different to the first Rx-Tx time value) may be associated with a second SL PRS transmission parameter or a second set of SL PRS transmission parameters. It is further noted that first and second SL PRS transmission parameters and/or first and second set of SL PRS transmission parameters may be different from each other. As one example, the first SL PRS transmission parameter or the first set of SL PRS transmission parameters may define or be associated with a first SL PRS sequence and the second SL PRS transmission parameter or the second set of SL PRS transmission parameters may define or be associated with a second SL PRS sequence (that is different from the first SL PRS sequence).

In one example, each Rx-Tx time value may include a symbol level time offset (that is to be applied) from the beginning of SL PRS (SL PRS_A) transmission slot and/or subframe level (or slot level) time offset from the SL PRS (SL PRS_T) receive time. In another example, the Rx-Tx time value may include a symbol level time offset (that is to be applied) and/or subframe level (or slot level) time offset from a certain configured or pre-configured response time value. According to at least one example embodiment, the Rx-Tx time values may be discrete values between a minimum and a maximum. The values may be configured or pre-configured as determined based on empirical evidence, network conditions, network characteristics, device characteristics, or the like.

As mentioned similarly above, the Rx-Tx time pool configuration may be provided to the target UE UE-T and/or the anchor UE UE-A1 by another UE (e.g., a server UE), another configuration or pre-configuration, a LMF (not shown) using the Long-Term Evolution positioning protocol (LPP) or by a gNB via a system information message (e.g., prior to establishing the report-free SL RTT positioning session between the target UE UE-T and the anchor UE UE-A1).

In another example, the Rx-Tx time pool configuration may be configured or pre-configured at the target UE UE-T and/or the anchor UE UE-A1.

In yet another example, the target UE UE-T may provide the Rx-Tx time pool configuration to the anchor UE UE-A1 (e.g., during the SL RTT positioning session). In this example, the target UE UE-T may generate the Rx-Tx time pool configuration or receive the Rx-Tx time pool configuration from the LMF, gNB, another UE (e.g., a server UE) or another configuration or pre-configuration.

In still another example, the anchor UE UE-A1 may provide the Rx-Tx time pool configuration to the target UE UE-T. In this example, the anchor UE UE-A may generate the Rx-Tx time pool configuration or receive the Rx-Tx time pool configuration from the LMF, the gNB, another UE (e.g., a server UE) or another configuration or pre-configuration.

According to at least one example embodiment, the SL PRS transmission parameters included in the Rx-Tx time pool configuration may include SL PRS sequences, wherein each of the SL PRS sequences is mapped to a Rx-Tx time value form among the pool of Rx-Tx time values. In this example, the SL PRS sequences may have associated SL PRS sequence identifiers (IDs), which are stored with the Rx-Tx values in a mapping table format that maps each Rx-Tx time value to a unique SL PRS sequence ID, and in turn a SL PRS sequence. An example of such a mapping table is shown below in Table 1.

TABLE 1

| Rx-Tx time values | SL PRS Sequence IDs |
|---|---|
| Rx-Tx time_1 | SL PRS Sequence ID_1 |
| Rx-Tx time_2 | SL PRS Sequence ID_2 |
| . | . |
| . | . |
| . | . |
| Rx-Tx time_N | SL PRS Sequence ID_N |

In at least one example embodiment, a SL PRS sequence ID may refer to more than one SL PRS transmission parameter. For example, the SL PRS sequence ID may reference both the code of the SL PRS sequence and the frequency resource (e.g., resource pool, Bandwidth Part (BWP)) for the SL PRS transmission. In more detail, for example, a SL PRS sequence ID may refer to a certain SL PRS sequence (with code-based ID) in a certain resource pool (with resource pool ID) such that each Rx-Tx time value in the pool of Rx-Tx time values is mapped to a unique set of SL PRS transmission parameters. In yet another example, the SL PRS transmission parameters included in the Rx-Tx time pool configuration may include different time-reference resources (comb-offset), different resource pools identified by resource pool IDs (see example mapping table in Table 2), different frequency offsets identified by frequency offset IDs (see example mapping table in Table 3) (sometimes referred to herein as frequency offset information), or the like. Although examples of SL PRS transmission parameters are discussed herein, example embodiments should not be limited to these examples.

TABLE 2

| Rx-Tx time values | Resource Pool IDs |
|---|---|
| Rx-Tx time_1 | Resource pool 1 |
| Rx-Tx time_2 | Resource pool 2 |
| . | . |
| . | . |
| . | . |
| Rx-Tx time_N | Resource pool N |

TABLE 3

| Rx-Tx time values | Frequency Offset |
|---|---|
| Rx-Tx time_1 | Frequency Offset 1 |
| Rx-Tx time_2 | Frequency Offset 2 |
| . | . |
| . | . |
| . | . |
| Rx-Tx time_N | Frequency Offset N |

Returning to FIG. 2A, at S302, the target UE UE-T transmits a (first) SL PRS (SL PRS_T) to the anchor UE UE-A1 as part of the SL RTT positioning session.

At S303 the anchor UE UE-A1 selects, as the Rx-Tx time for subsequent SL PRS transmission, a Rx-Tx time value from the pool of Rx-Tx time values indicated in the Rx-Tx time pool configuration. For example, S303 may be performed based on (e.g., upon receiving) the SL PRS from the target UE UE-T. As discussed herein, the anchor UE UE-A1 may select the Rx-Tx time value based on, for example, at least one of an interference situation at the SL PRS channel (i.e., SL channel or SL PRS channel characteristics between UE-T and UE-A1), priority of the SL PRS transmission, positioning requirements of the target UE, etc. In one example, the anchor UE UE-A1 may select the Rx-Tx time value that suppresses and/or minimizes its SL PRS transmission impact on other SL PRS transmissions (from other UEs).

In some examples, enabling UE-A1 to select Rx-Tx time value from a pool of values provides the benefit of avoiding interference and/or poor radio conditions. For example, if the channel characteristics of radio channel used to transmit and/or receive SL PRSs (e.g., as transmitted in S305) are not sufficiently good utilizing a first SL PRS transmission parameter(s) for transmitting SL PRS with required probability (e.g., certain position requirement) for successful reception by UE-T, UE-A1 may select a second SL PRS transmission parameter(s) that would more likely enable successful transmission and reception of the SL PRS. In a simple example, the second SL PRS transmission parameter(s) may enable later transmission of the SL PRS compared with the first SL PRS transmission parameter(s). Thus, the radio conditions may have time to improve before transmission of the SL PRS. In another example, the second SL PRS transmission parameter(s) enable higher transmission power compared with the first SL PRS transmission parameter(s). In another example, the second SL PRS transmission parameter(s) may enable denser PRS comb structure and/or higher repetition rate of the SL PRS symbols compared with the first SL PRS transmission parameter(s). As discussed, each SL PRS transmission parameter or parameter set may be associated with a (different) Rx-Tx time value, and thus the used transmission parameter may dictate what Rx-Tx time value is selected (or the other way around). In some examples, the transmission parameter defines an offset (i.e., the Rx-Tx time value) between the reception of the SL PRS (S302) and transmission of SL PRS (S305). In some examples, the only difference between the transmission parameters is that they define different offsets according to the selected Rx-Tx time.

With regard to the mapping table shown in Table 1, for example, among the listed Rx-Tx time values in the Rx-Tx time pool configuration, the anchor UE UE-A1 may select Rx-Tx time_2 as the Rx-Tx time value time if Rx-Tx time Rx-Tx time_2 offers a SL PRS transmission resource with lower (e.g., below a threshold, relatively low or minimum) expected interference among the pool of Rx-Tx time values.

At S304, the anchor UE UE-A1 identifies the at least one SL PRS transmission parameter associated with the Rx-Tx time value selected at S303. Again with regard to the example shown in Table 1, for the selected Rx-Tx time Rx-Tx time_2, the anchor UE UE-A1 identifies the SL PRS sequence ID SL PRS sequence ID_2, and in turn the SL PRS sequence associated therewith, as a SL PRS transmission parameter for transmitting the response SL PRS (SL PRS_A) to the target UE UE-T.

At S305, the anchor UE UE-A1 transmits the response (second) SL PRS (SL PRS_A) using the identified at least one SL PRS transmission parameter (e.g., the SL PRS sequence associated with SL PRS sequence ID_2) and as per the selected Rx-Tx time value (e.g., Rx-Tx time_2). For example, the anchor UE UE-A1 may select the transmission time of the SL PRS according to the selected Rx-Tx time value and transmit at the selected transmission time.

In the example in which the at least one SL PRS transmission parameter is a SL PRS sequence, the SL PRS sequence ID corresponding to the selected SL PRS sequence need not be transmitted or explicitly signaled to the target UE UE-T by the anchor UE UE-A1. Rather, the SL PRS sequence ID may be conveyed to the target UE UE-T implicitly through transmission of the SL PRS sequence. Similarly, the selected Rx-Tx time value also need not be transmitted explicitly to the target UE UE-T. Rather, the Rx-Tx time value is conveyed to the target UE UE-T implicitly through use of the SL PRS sequence.

At S306, upon receipt of the (second) SL PRS (SL PRS_A), the target UE UE-T identifies the at least one SL PRS transmission parameter (e.g., the SL PRS sequence associated with SL PRS sequence ID_2) used in transmitting the response SL PRS (SL PRS_A) by the anchor UE UE-A1. In one example, the target UE UE-T may identify the at least one SL PRS transmission parameter based on characteristics of the received SL PRS (SL PRS_A) (also referred to herein as (sidelink positioning reference signal characteristics). For example, where the SL PRS sequence is used as the at least one SL PRS transmission parameter, the target UE UE-T may perform a correlation between the received SL PRS sequence (SL PRS characteristics) and a set of SL PRS sequences to identify the SL PRS sequence used by the anchor UE-A1. In another example, where the resource pool is used as the at least one SL PRS transmission parameter, the target UE UE-T identifies the resource pool used for SL PRS transmission at the anchor UE based on the radio frequency range within which the SL PRS is received at the target UE.

At S307, the target UE UE-T determines the Rx-Tx time value (e.g., Rx-Tx Time_2 in the example above) used at the anchor UE UE-A1 for transmitting the response SL PRS (SL PRS_A) by the anchor UE UE-A1 based on the identified at least one SL PRS transmission parameter (e.g., SL PRS sequence associated with SL PRS sequence ID_2) and the Rx-Tx time pool configuration (e.g., the mapping table correlating the Rx-Tx time values with the SL PRS transmission parameters or sets thereof). For example, the target UE UE-T determines the Rx-Tx time value by identifying the Rx-Tx time associated with the identified at least one SL PRS transmission parameter in the mapping table.

At S308, the position of the target UE UE-T may be estimated using the Rx-Tx time value determined at S307. The estimation of the target UE UE-T may be done in any known manner and may be performed at the target UE UE-T or another network element. For example, the target UE UE-T (or other network element) may to estimate the propagation delay based on, among other things, the Rx-Tx time value, and in turn, determine the distance between the target UE UE-T and the anchor UE UE-A1. The determined distance may then be used to determine position information for the target UE UE-T.

According to one or more example embodiments, the position information may be UE-based position information generated according to a UE-based positioning method or UE-assisted position information generated according to a UE-assisted positioning method. In one example, the position information may be generated according to round trip time (RTT) positioning.

According to one or more example embodiments, the target UE UE-T may report a RTT measurement, anchor UE identifier, and target UE identifier to a location server or the LMF for position determination at the location server or LMF.

In connection with an example embodiment in which the at least one SL PRS transmission parameter is a SL PRS sequence, the target UE UE-T may attempt to detect more than one (e.g., all or substantially all) SL PRS sequences corresponding to a feasible response time, as the target UE UE-T may not be aware of the actual SL PRS sequence selected by the anchor UE UE-A1. To address this issue, in at least one example embodiment, the anchor UE UE-A1 may provide the target UE UE-T with a subset of SL PRS sequence IDs (e.g., a selected set within the Rx-Tx time pool configuration) that the anchor UE UE-A1 may be more likely to be utilized relative to others of the SL PRS sequence IDs. In this example embodiment, the subset of SL PRS sequence IDs may be exchanged via signaling between the anchor UE UE-A1 and the target UE UE-T prior to implicitly indicating Rx-Tx time values at S305. In one example, the subset of SL PRS sequence IDs may be exchanged via signaling during the configuration at S301.

In another example embodiment, the anchor UE UE-A1 may indicate preference on usage of various SL PRS sequences (or other SL PRS transmission parameters). For example, the anchor UE UE-A1 may assign indices to SL PRS sequence IDs indicating probability of use of various SL PRS sequences. For example, the anchor UE UE-A1 may assign a lower index to a given SL PRS sequence ID indicating a higher probability that the anchor UE UE-A1 will use the given SL PRS sequence. In this case, the target UE UE-T may prioritize detection of SL PRS sequences in order of the indices assigned (e.g., lowest to highest). The indicated preference may be utilized in conjunction with an identified subset of SL PRS sequence IDs.

According to at least one other example embodiment, the Rx-Tx time pool configuration may indicate a default (or preferred) value for the Rx-Tx time value at the anchor UE UE-A1. For example, the shortest Rx-Tx time value among the pool of Rx-Tx time values may be indicated as the default Rx-Tx time value. The anchor UE UE-A1 may select the default Rx-Tx time value absent other reason not to do so (e.g., the default Rx-Tx time value is not expected to offer suitable or relatively high SL PRS reception quality at the target UE UE-T) as it may simplify reception of SL PRS at the target UE UE-T (e.g., the target UE UE-T need only try one value of SL PRS sequence).

FIG. 2B is a signal flow diagram illustrating a method according to example embodiments. The example embodiment shown in FIG. 2B illustrates actions and/or operations S303 and S305 performed at the anchor UE UE-A1 in the method shown and described above with regard to FIG. 2A. Accordingly, only a brief discussion of these actions and/or operations will be provided here.

Referring to FIG. 2B, at S303 the anchor UE UE-A1 selects, as the Rx-Tx time for a SL PRS transmission, a Rx-Tx time value from a pool of Rx-Tx time values indicated in the Rx-Tx time pool configuration.

At S305, the anchor UE UE-A1 transmits the SL PRS (SL PRS_A) using the identified at least one SL PRS transmission parameter (e.g., the SL PRS sequence associated with SL PRS sequence ID_2) and as per the selected Rx-Tx time value (e.g., Rx-Tx time_2).

FIG. 2C is a signal flow diagram illustrating a method according to example embodiments.

The example embodiment shown in FIG. 2C illustrates actions and/or operations performed at the target UE UE-T in the method shown and described above with regard to FIG. 2A. For actions and/or operations already discussed with regard to FIG. 2A, a detailed discussion will not be repeated here.

Referring to FIG. 2C, at S305B, the target UE UE-T receives the transmitted SL PRS (SL PRS_A) using at least one SL PRS transmission parameter (e.g., the SL PRS sequence associated with SL PRS sequence ID_2) and as per a Rx-Tx time value (e.g., Rx-Tx time_2) selected at the anchor UE UE-A1 as discussed herein above.

At S306, the target UE UE-T identifies the at least one SL PRS transmission parameter (e.g., the SL PRS sequence associated with SL PRS sequence ID_2) used in transmitting the SL PRS (SL PRS_A) by the anchor UE UE-A1.

At S307, the target UE UE-T determines the Rx-Tx time value (e.g., Rx-Tx Time_2) used at the anchor UE UE-A1 for transmitting the SL PRS (SL PRS_A) by the anchor UE UE-A1 based on the identified at least one SL PRS transmission parameter (e.g., SL PRS sequence associated with SL PRS sequence ID_2) and the Rx-Tx time pool configuration. The determined Rx-Tx time value may be utilized for determining position information for the target UE UE-T as discussed herein above.

Although some example embodiments are discussed herein with regard to specific examples (e.g., with regard to SL PRS sequences), example embodiments should not be limited to these examples. Rather, for example, these example embodiments may also be applicable to other SL PRS transmission parameters.

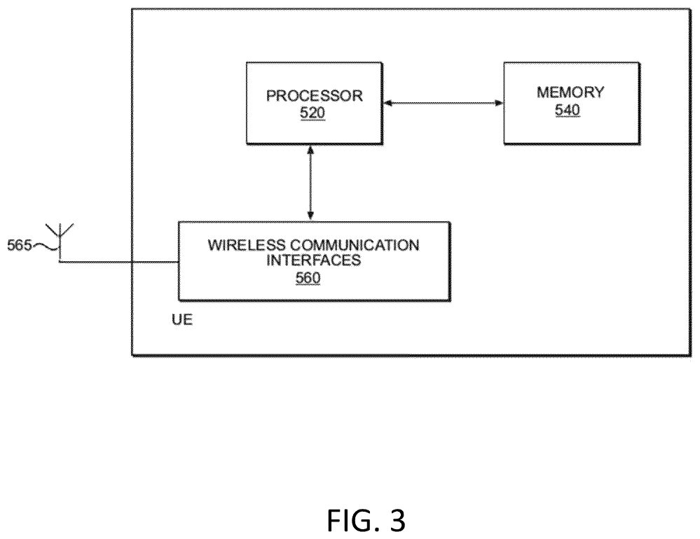

FIG. 3 illustrates an example embodiment of one or more of the UEs shown in FIGS. 1 and 2.

As shown, the UE includes: a memory 540; a processor 520 connected to the memory 540; various interfaces 560 connected to the processor 520; and one or more (e.g., a plurality of) antennas or antenna panels 565 connected to the various interfaces 560. The various interfaces 560 and the antenna 565 may constitute a transceiver for transmitting/receiving data from/to other network elements (e.g., other UEs, gNBs, LMFs, TRPs, etc.) via one or more antenna beams. As will be appreciated, depending on the implementation of the UE, the UE may include many more components than those shown in FIG. 3. However, it is not necessary that all of these generally conventional components be shown in order to disclose the illustrative example embodiment.

The memory 540 may be a computer readable storage medium that generally includes a random access memory (RAM), read only memory (ROM), and/or a permanent mass storage device, such as a disk drive. The memory 540 also stores an operating system and any other routines/modules/applications for providing the functionalities of the UE to be executed by the processor 520. These software components may also be loaded from a separate computer readable storage medium into the memory 540 using a drive mechanism (not shown). Such separate computer readable storage medium may include a disc, tape, DVD/CD-ROM drive, memory card, or other like computer readable storage medium (not shown). In some example embodiments, software components may be loaded into the memory 540 via one of the various interfaces 560, rather than via a computer readable storage medium.

The processor 520 may be configured to carry out instructions of a computer program by performing the arithmetical, logical, and input/output operations of the system. Instructions may be provided to the processor 520 by the memory 540.

The various interfaces 560 may include components that interface the processor 520 with the antenna 565, or other input/output components. As will be understood, the various interfaces 560 and programs stored in the memory 540 to set forth the special purpose functionalities of the UE will vary depending on the implementation of the UE.

The interfaces 560 may also include one or more user input devices (e.g., a keyboard, a keypad, a mouse, or the like) and user output devices (e.g., a display, a speaker, or the like).

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment or other network elements and/or hardware. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, or other network elements, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUS, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. A user equipment comprising:
at least one processor; and
at least one memory storing instructions that, when executed by the at least one processor, cause the user equipment to
select a sidelink response time value from a plurality of sidelink response time values configured for the user equipment and a target user equipment, and
transmit a positioning reference signal to the target user equipment based at least partly on at least one positioning reference signal transmission parameter associated with the selected sidelink response time value.

2. The user equipment of claim 1, wherein the at least one positioning reference signal transmission parameter includes at least one of a positioning reference signal sequence for the positioning reference signal, a positioning reference signal sequence for a positioning reference signal identifier, frequency resources for transmitting the positioning reference signal, time resources for transmitting the positioning reference signal, or frequency offset information.

3. The user equipment of claim 1, wherein the at least one positioning reference signal transmission parameter is a resource pool used to transmit the positioning reference signal to the target user equipment.

4. The user equipment of claim 1, wherein the at least one memory stores instructions that, when executed by the at least one processor, cause the user equipment to select transmission time of the positioning reference signal according to the selected sidelink response time value.

5. The user equipment of claim 1, wherein
the at least one positioning reference signal transmission parameter is associated with a parameter identifier, and
the sidelink response time value is associated with the at least one positioning reference signal transmission parameter via a mapping between the sidelink response time value and the parameter identifier.

6. The user equipment of claim 5, wherein the at least one positioning reference signal transmission parameter includes at least one of a positioning reference signal sequence for the positioning reference signal or frequency resources for transmitting the positioning reference signal.

7. The user equipment of claim 5, wherein the sidelink response time value is mapped to the parameter identifier via a mapping table.

8. The user equipment of claim 1, wherein the at least one memory stores instructions that, when executed by the at least one processor, cause the user equipment to receive a positioning reference signal from the target user equipment prior to selecting the sidelink response time value, wherein
the sidelink response time value indicates a time difference between receipt of the positioning reference signal from the target user equipment and transmission of the positioning reference signal to the target user equipment.

9. The user equipment of claim 8, wherein the at least one memory stores instructions that, when executed by the at least one processor, cause the user equipment to select the sidelink response time value from the plurality of sidelink response time values based on at least one of sidelink channel characteristics between the user equipment and the target user equipment, positioning requirements for the target user equipment, or priority information associated with positioning reference signal transmissions from at least one of the user equipment or the target user equipment.

10. The user equipment of claim 1, wherein transmission of the positioning reference signal to the target user equipment based at least partly on the at least one positioning reference signal transmission parameter indicates the sidelink response time value to the target user equipment without explicit transmission of the sidelink response time value to the target user equipment.

11. A method comprising:
selecting, at a user equipment, a sidelink response time value from a plurality of sidelink response time values configured for the user equipment and a target user equipment; and
transmitting, from the user equipment, a positioning reference signal to the target user equipment based at least partly on at least one positioning reference signal transmission parameter associated with the selected sidelink response time value.

12. A user equipment comprising:
at least one processor; and
at least one memory storing instructions that, when executed by the at least one processor, cause the user equipment to
receive a positioning reference signal transmitted by an anchor user equipment,
identify at least one positioning reference signal transmission parameter associated with the received positioning reference signal, and
determine, based on the at least one positioning reference signal transmission parameter, a sidelink response time value for transmission of the received positioning reference signal by the anchor user equipment, the sidelink response time value being for determining position information for the user equipment.

13. The user equipment of claim 12, wherein the position information includes at least one of an absolute position, a relative position, or ranging information for the user equipment.

14. The user equipment of claim 12, wherein the at least one positioning reference signal transmission parameter includes at least one of a positioning reference signal sequence for the positioning reference signal, a positioning reference signal sequence for a positioning reference signal identifier, frequency resources for transmitting the received positioning reference signal, time resources for transmitting the received positioning reference signal, or frequency offset information.

15. The user equipment of claim 12, wherein the at least one positioning reference signal transmission parameter is a resource pool used to transmit the received positioning reference signal.

16. The user equipment of claim 12, wherein
the at least one positioning reference signal transmission parameter is associated with a parameter identifier,
the sidelink response time value is associated with the at least one positioning reference signal transmission parameter via a mapping between the parameter identifier and the sidelink response time value, and
the at least one memory stores instructions that, when executed by the at least one processor, cause the user equipment to determine the sidelink response time value based on the parameter identifier.

17. The user equipment of claim 16, wherein the sidelink response time value is mapped to the parameter identifier via a mapping table.

18. The user equipment of claim 16, wherein the at least one positioning reference signal transmission parameter includes at least one of a positioning reference signal sequence for the positioning reference signal or frequency resources for transmitting the positioning reference signal.

19. The user equipment of claim 12, wherein the at least one memory stores instructions that, when executed by the at least one processor, cause the user equipment to transmit a positioning reference signal to the anchor user equipment, wherein
the sidelink response time value is a time difference between receipt of the position reference signal transmitted to the anchor user equipment and transmission of the position reference signal from the anchor user equipment.

20. The user equipment of claim 16, wherein the at least one memory stores instructions that, when executed by the at least one processor, cause the user equipment to determine the sidelink response time value based on the at least one positioning reference signal transmission parameter without explicit receipt of the sidelink response time value from the anchor user equipment.
